(19) United States
(12) Patent Application Publication
(10) Pub. No.: US 2019/0086601 A1
(43) Pub. Date: Mar. 21, 2019

(54) BACKLIGHT MODULE AND DISPLAY DEVICE

(71) Applicants: QINGDAO HISENSE ELECTRONICS CO., LTD., Qingdao (CN); HISENSE INTERNATIONAL CO., LTD., Qingdao (CN); HISENSE USA CORPORATION, Suwanee, GA (US)

(72) Inventors: JIBING ZHANG, QINGDAO (CN); KEJIAN OU, QINGDAO (CN)

(21) Appl. No.: 15/922,753

(22) Filed: Mar. 15, 2018

(30) Foreign Application Priority Data
Sep. 15, 2017 (CN) 201710832602.7

(51) Int. Cl. F21V 8/00

(52) U.S. Cl. CPC G02B 6/0031; G02B 6/0055; G02B 6/0018; G02B 6/002; G02B 6/0091

(57) ABSTRACT

A backlight module and a display device are provided. The backlight module includes a light source, a light guide plate and a reflection sheet. A side of the light guide plate includes a light-incident surface perpendicular to a bottom surface, a first inclined plane, and a second inclined plane. An intersecting line between a plane in which the first inclined plane lies and a plane in which the second inclined plane lies is located outside of the light guide plate, and the intersecting line is parallel with the bottom surface. The first and second inclined planes are configured such that a total reflection occurs on at least a part of the light at the first and second inclined planes, and thus an incidence angle of light emitted towards the bottom surface is greater than or equal to a critical angle at the bottom surface.

### CROSS-REFERENCE TO RELATED APPLICATIONS

This application claims priority to Chinese Patent Application No. 201710832602.7, filed with the Chinese Intellectual Property Office on Sep. 15, 2017, entitled “Backlight Module and Display Device”, which is incorporated herein by reference in its entirety.

### TECHNOLOGY FIELD

The present disclosure relates to the field of display technology and, in particular, to a backlight module and a display device.

### BACKGROUND

The disclosure in this background section is only the technology related to the present disclosure and does not necessarily constitute prior art.

A backlight module is a device that provides a uniformly distributed light to a display panel. A backlight module generally includes a light source, a light guide plate and a reflection sheet. FIG. 1, as shown, is a structural schematic diagram of an edge-lit backlight module. A light source 11 may be a light emitting diode which is located outside a light-incident surface of the light guide plate 12. The light guide plate 12 has a light-emergent surface for emitting uniform light and a bottom surface opposite to the light-emergent surface. The bottom surface is provided with a plurality of spots 121, and a reflection sheet 13 is located outside the bottom surface of the light guide plate 12. After the backlight module is activated, the light source 11 emits light into the light guide plate 12 from a side of the light guide plate 12, and the light, after entering the light guide plate, is emitted towards both sides of the light guide plate. A total reflection will occur on the light emitted towards the light-emergent surface of the light guide plate, and the light emitted towards the light-emergent surface of the light guide plate will be emitted towards the bottom surface of the light guide plate. Among the light emitted towards the bottom surface of the light guide plate, a total reflection will occur on the light emitted towards areas other than the spots, and the light emitted towards the areas other than the spots will be emitted towards the light-emergent surface of the light guide plate, and the light emitted towards the spots will diffuse. A part of the diffusing light will be emitted out from the light-emergent surface of the light guide plate, and the other part will be emitted from the bottom surface of the light guide plate towards the reflection sheet and be reflected by the reflection sheet towards the light-emergent surface of the light guide plate.

### SUMMARY

According to an aspect of embodiments of the present disclosure, a backlight module is provided. The backlight module includes a light source, a light guide plate and a reflection sheet; where the light source and the reflection sheet are located outside of the light guide plate, and the light guide plate includes:

a bottom surface disposed opposite to the reflection sheet;

a light-emergent surface disposed opposite to the bottom surface and parallel with the bottom surface;

a light-incident surface located at a side of the light guide plate, perpendicular to the bottom surface and disposed opposite to the light source;

a first inclined plane disposed between the light-incident surface and the light-emergent surface;

a second inclined plane disposed between the light-incident surface and the bottom surface.

According to another aspect of the embodiments of the present disclosure, a display device including the backlight module described in the first aspect is provided.

Based on the present disclosure, it is obvious that more implementation scenarios can be obtained. It should be understood that numerous implementation scenarios of the present disclosure may be implemented separately or may be a combination of one or more implementation scenarios. The implementation scenarios presented in the present disclosure are presented for the purpose of better describing and presenting the present disclosure and do not constitute a limitation to the present disclosure.

### BRIEF DESCRIPTION OF THE DRAWINGS

To describe the technical solutions in the embodiments of the present disclosure more clearly, the drawings required for describing the embodiments are now briefly introduced in the below. Apparently, the drawings in the following description are merely some embodiments of the present disclosure, not all feasible embodiments. For those skilled in the art, other drawings may be obtained according to these drawings without any creative work.

FIG. 1 is a structural schematic diagram of a backlight module in the related art;

FIG. 2 is a schematic diagram of a light path of a backlight module in the related art;

FIG. 3 is a structural schematic diagram of a backlight module provided by the embodiments of the present disclosure;

FIG. 4 is a structural schematic diagram of another backlight module provided by the embodiments of the present disclosure;

FIG. 5A is a schematic diagram of light paths of the backlight module shown in FIG. 4;

FIG. 5B is another schematic diagram of light paths of the backlight module shown in FIG. 4;

FIG. 5C is another schematic diagram of light paths of the backlight module shown in FIG. 4;

FIG. 5D is another schematic diagram of light paths of the backlight module shown in FIG. 4;

FIG. 5E is another schematic diagram of light paths of the backlight module shown in FIG. 4.

Through the above-mentioned drawings, explicit embodiments of the present disclosure have been shown, and will be described in more detail in the below. These drawings and textual descriptions are not intended to limit the scope of the conception of the present disclosure in any way, but to explain the concepts of the present disclosure for those skilled in the art by referring to specific embodiments.

### DETAILED DESCRIPTION

To make the objects, technical solutions and advantages of the present disclosure more comprehensible, the embodiments of the present disclosure are further described in detail below with reference to the drawings.

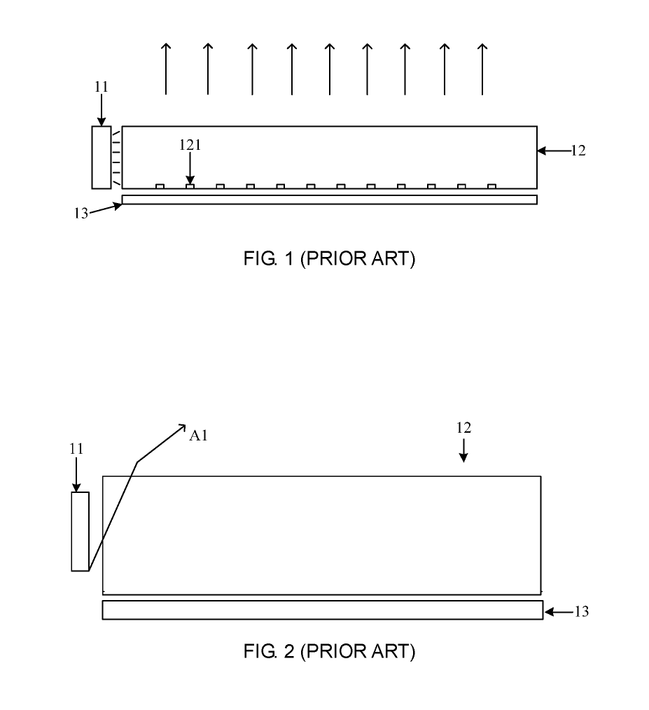

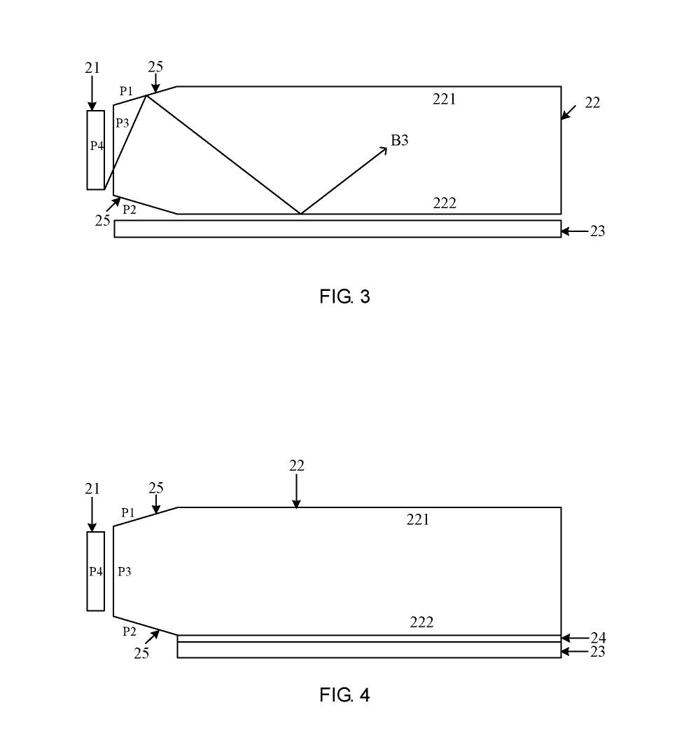

A structure of a light guide plate in the related art is shown in FIG. 1. In an ideal state, a total reflection should occur on light irradiating on a portion of a bottom surface of the light guide plate without a spot. However, in the related art, as shown in FIG. 2, a part of the light emitted from the light source 11, for example, the light A1 in FIG. 2, after being emitted from a luminous surface of the light source 11 towards the light guide plate 12, will be directly emitted towards a light-emergent surface of the light guide plate 12 with a small incidence angle and be directly emitted out from a side of the light-emergent surface near the light source 11; and a part of the light (not shown), after being emitted from the luminous surface of the light source 11 towards the light guide plate 12, will be emitted towards the bottom surface of the light guide plate 12 with a small incidence angle, penetrated the bottom surface of the light guide plate 12 and emitted towards the reflection sheet 13, and, after being reflected by the reflection sheet 13, be emitted out from a side of a light-emergent surface 121 of the light guide plate 12, near the light source. This light will make the light-emergent surface of the light guide plate 12 have a higher brightness on the side near the light source 11.

In another backlight module in the related art, the bottom surface of the light guide plate is provided with a glue layer, which directly adheres the reflection sheet to the bottom surface of the light guide plate. Since the refractive index of the glue layer is greater than the refractive index of air, the critical angle of the intersecting plane between the bottom surface and the glue layer is greater than the critical angle of the intersecting plane between the light-emergent surface and the air. This results in that, in the light guide plate, a part of light emitted towards the intersecting plane between the light guide plate and the glue layer may directly penetrate the bottom surface of the light guide plate and emit on the light guide plate, and the reflection sheet will reflect the light towards the light-emergent surface of the light guide plate, so that a bright area appears on the light-emergent surface of the light guide plate, which affects the uniformity of the light emitted by the backlight module.

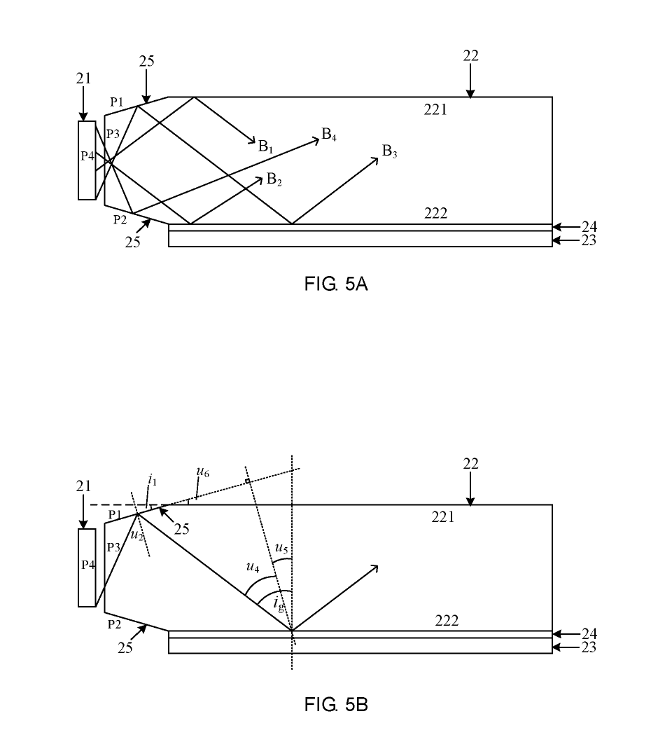

The embodiments of the present disclosure provide a side-in backlight module, the structure of which may be as shown in FIG. 3. The backlight module may include a light source 21, a light guide plate 22 and a reflection sheet 23.

The light source 21 and the reflection sheet 23 are both located outside of the light guide plate 22.

The light guide plate 22 includes a bottom surface 222 and a light-emergent surface 221. The bottom surface 222 and the light-emergent surface 221 are generally disposed in a parallel manner. The reflection sheet 23 is disposed on a bottom side of the light guide plate 22 and parallel with the bottom surface 222 of the light guide plate 22.

The light guide plate 22 further includes a first inclined plane P1, a light-incident surface P3 and a second inclined plane P2 sequentially connected between the light-emergent surface 221 and the bottom surface 222. The light-incident surface P3 is perpendicular to the bottom surface 222 and is disposed opposite to a luminous surface of the light source 21 located outside of the light guide plate 22. The first inclined plane P1 is connected between the light-emergent surface 221 and the light-incident surface P3, and the second inclined plane P2 is connected between the light-incident surface P3 and the bottom surface 222. The light-incident surface P3 does not abut the light-emergent surface 221 and the bottom surface 222. An intersecting line between a plane in which the first inclined plane P1 lies and a plane in which the second inclined plane P2 lies is located outside of the light guide plate 22, and the intersecting line is parallel with the bottom surface 222. The first inclined plane P1 and the second inclined plane P2 are configured such that a total reflection occurs on at least part of light emitted from the light-incident surface P3 to the first inclined plane P1 at the first inclined plane P1, a total reflection occurs on at least part of light emitted from the light-incident surface P3 to the second inclined plane P2 at the second inclined plane P2, and a minimum incidence angle of light emitted towards the bottom surface 222 of the light guide plate 22 is greater than or equal to a critical angle at a place where a total reflection occurs on the bottom surface 222.

In the backlight module provided by the embodiments of the present disclosure, a side of the light guide plate 22 is provided with two inclined planes P1 and P2. These two inclined planes P1 and P2 increase the incidence angle of the light emitted towards the bottom surface 222 of the light guide plate 22, and cause the incidence angle to be greater than or equal to the critical angle at a place where a total reflection occurs on the bottom surface, so that a total reflection occurs on the light at the bottom surface 222 of the light guide plate 22 without the light directly penetrating the bottom surface 222 and being emitted towards the reflection sheet 23, and thus a bright area does not appear on the light-emergent surface 221 of the light guide plate 22. Therefore, the embodiment of the present disclosure solves the problem that a part of light emitted towards the bottom surface of the light guide plate may directly penetrate the bottom surface and emit on the light guide plate, and the reflection sheet reflects the light towards the light-emergent surface of the light guide plate, so that a bright area appears on the light-emergent surface of the light guide plate, which affects the uniformity of the light emitted by the backlight module in the related art, and realizes the effect of strong uniformity of the light emitted by the backlight module.

In the embodiments of the present disclosure and the following embodiments, the light source 21 may be a point light source or a surface light source. The luminous surface P4 of the light source 21 may be disposed in parallel with the light-incident surface P3. In some embodiments, the light source 21 may be a light emitting diode (LED). In some embodiments, the light source 21 may be composed of an LED and a quantum tube, which is a light source with uniform light emission and better heat dissipation performance. In some embodiments of the present disclosure, a plurality of LEDs may also be disposed on a printed circuit board (PCB) to form the light source 21, and the LEDs are disposed opposite to the light-incident surface P3 of the light guide plate 22. The use of a plurality of LEDs to form the light source 21 can provide a stronger light uniformity and higher reliability.

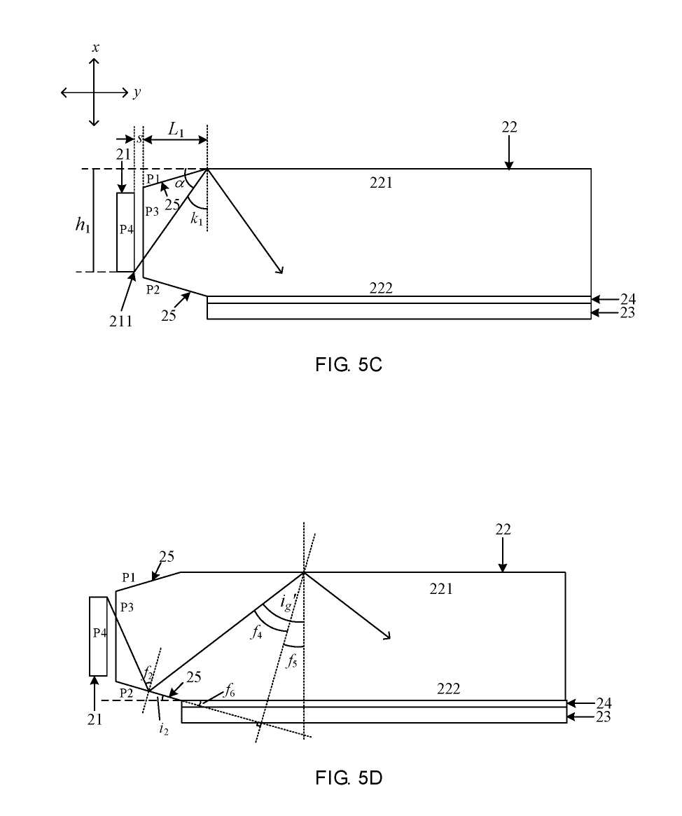

FIG. 4, as shown, is another backlight module provided by an embodiment of the present disclosure. The backlight module may include a light source 21, a light guide plate 22, a reflection sheet 23 and a glue layer 24. The reflection sheet 23 is adhered to the bottom surface of the light guide plate 22 via the glue layer 24.

The light-emergent surface 221 and the bottom surface 222 of the light guide plate 22 are generally parallel with each other. A side of the light guide plate 22 includes a first inclined plane P1, a light-incident plane P3 and a second inclined plane P2 which are sequentially connected. The light-incident surface P3 is perpendicular to the bottom surface 222 and is disposed opposite to the luminous surface P4 of the light source 21 disposed outside of the light guide plate 22. The first inclined plane P1 is disposed between the light-emergent surface 221 and the light-incident surface P3 of the light guide plate 22, the second inclined plane P2 is disposed between the light-incident surface P3 and the bottom surface 222 of the light guide plate 22, and the light-incident surface P3 does not abut the light-emergent surface 221 and the bottom surface 222. An intersecting line between a plane in which the first inclined plane P1 lies and a plane in which the second inclined plane P2 lies is located outside of the light guide plate 22, and the intersecting line is parallel with the bottom surface 222.

At least one of the first inclined plane P1 and the second inclined plane P2 can enable that, in the light of the light source 21 emitted into the light guide plate 22, a minimum incidence angle of the light emitted from the first inclined plane P1 towards the bottom surface 222 of the light guide plate 22 is greater than or equal to the critical angle i_{g} of the interface between the bottom plane 222 and the glue surface 24. The critical angle i_{g} of the intersecting plane between the bottom plane 222 and the glue surface 24 may meet a formula of i_{g}=arcsin(n₁/n₂), where i_{g} is the critical angle of the intersecting plane interface between the bottom plane 222 and the glue surface 24, n₁ is the refractive index of the glue layer 24, n₂ is the refractive index of the light guide plate 22. When the minimum incidence angle of the light emitted towards the bottom surface 222 of the light guide plate 22 is greater than or equal to the critical angle i_{g} of the interface between the bottom plane 222 and the glue surface 24, a total reflection occurs on the light emitted towards the bottom surface 222 of the light guide plate 22 without the light emitted towards the bottom surface 222 of the light guide plate 22 being emitted out of the interface between the light guide plate 22 and the glue surface 24.

In the backlight module provided by the embodiment of the present disclosure, a side of the light guide plate is provided with two inclined planes P1 and P2. These two inclined planes can increase the incidence angle of the light emitted towards the interface between the light guide plate 22 and the glue surface 24, and cause the incidence angle to be greater than or equal to the critical angle i_{g} of the interface between the bottom plane 222 and the glue surface 24, so that a total reflection occurs on the light at the interface between the light guide plate 22 and the glue surface 24 without the light directly penetrating the bottom surface 222 of the light guide plate 22 and being emitted towards the reflection sheet 23, and thus a bright area does not appear at the light-emergent surface 221 of the light guide plate 22. Therefore, the embodiment of the present disclosure solves the problem that a part of light emitted towards the interface between the light guide plate and the glue layer may directly penetrate the bottom surface of the light guide plate and irradiate on the light guide plate, and the reflection sheet will reflect the light towards the light-emergent surface of the light guide plate, so that a bright area appears at the light-emergent surface of the light guide plate, which affects the uniformity of the light emitted by the backlight module in the related art, and realizes the effect of strong uniformity of the light emitted by the backlight module.

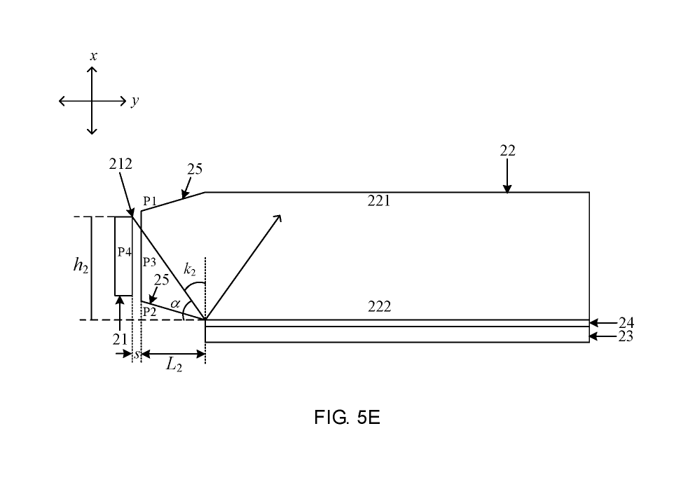

FIG. 5A is a schematic diagram of a light path of the backlight module shown in FIG. 4. The light irradiated from the light source 21 into the light guide plate 22 may include light B₁ directly emitted to the light-emergent surface 221 of the light guide plate 22, light B₂ directly emitted to the bottom surface 222 of the light guide plate 22, light B₃ directly emitted to the bottom surface 222 of the light guide plate 22 after being reflected by the first inclined plane P1, and light B₄ directly emitted to the light-emergent surface 221 of the light guide plate 22 after being reflected by the second inclined plane P2. These lights can be reflected constantly in the light guide plate. If a total reflection occurs on the light when the light is irradiated on the bottom surface 222 of the light guide plate 22 for the first time, a total reflection can still occur on the light when the light is reflected at the bottom surface 222 again, except for the situation that they are irradiated on the spot (not shown in FIG. 5A).

The first inclined plane P1 and the second inclined plane P2 in the backlight module provided by the embodiment of the present disclosure enable a total reflection to occur on a part of the light emitted to the first inclined plane P1 or the second inclined plane P2 at the first inclined plane P1 or the second inclined plane P2, so that the light can be transmitted in the light guide plate in a direction away from the light source, thereby reducing the light emission on a side of the light-emergent surface 221 of the light guide plate, which is near the light source, and reducing the generation of bright edges. At the meantime, the light can be emitted to the bottom surface 222 or the light-emergent surface 221 of the light guide plate 22 at a larger incidence angle in comparing with the incidence angle of the light when being emitted to the first inclined plane P1 and the second inclined plane P2, thereby increasing the probability of the total reflection of this part of light inside the light guide plate 22.

FIG. 5B, as shown, is another schematic diagram of light paths of the backlight module shown in FIG. 4. The present embodiment describes the condition that the angle of the first inclined plane P1 satisfies with reference to the figure.

The light emitted from the light source 21 enters the light-incident surface P3 and refracts, the incidence angle of the light directly emitted towards the first inclined plane P1 is generally greater than or equal to the critical angle iₐ of the interface between the light guide plate 22 and the air, so that a total reflection occurs. Whenever the first inclined plane P1 deflects counterclockwise by 1 degree from the position where it is coplanar with the light-emergent surface 221, the incidence angle of the light directly irradiating to the first inclined plane P1 is deflected counterclockwise by 1 degree. Under the critical condition, when the incidence angle of the light emitted from the light source 21 to the interface between the bottom surface 222 and the glue surface 24 after being reflected by the first inclined plane P1 is the critical angle i_{g}, according to the geometric relationship, it can be seen that u₂=i₁+iₐ=u₄, u₅=i_{g}−u₄=u₆=i₁, and thus, i₁=(i_{g}−iₐ)/2, where i₁ is the angle between the first inclined plane P1 and the light-emergent surface 221, i_{g} is the critical angle of the interface between the bottom surface 222 and the glue layer, and iₐ is the critical angle of the interface between the light-emergent surface 221 and the air. Therefore, when i₁≥(i_{g}−iₐ)/2, the incidence angle of the light emitted from the light source 21 to the interface between the bottom surface 222 and the glue layer, after being reflected by the first inclined plane P1, will be greater than or equal to the critical angle i_{g}, so that a total reflection will occur on the light without the light being emitted into the glue layer 24 from the bottom surface 222. That is, a total reflection can occur on the light B₃ in FIG. 5A within the light guide plate before the light B₃ irradiates to the spot.

Therefore, the angle between the first inclined plane P1 and the light-emergent surface 221 satisfies a first angle formula of i₁≥(i_{g}−iₐ)/2, where i₁ is the angle between the first inclined plane and the light-emergent surface, i_{g} is a critical angle of the interface between the bottom surface 222 and the glue layer, i_{g}=arcsin(n₁/n₂), n₁ is the refractive index of the glue layer 24 (the refractive index of the glue layer is generally greater than 1 and less than the refractive index of the light guide plate, e.g., about 1.3), n₂ is the refractive index of the light guide plate 22 (e.g., about 1.49), and iₐ is the critical angle of the interface between the light-emergent surface 221 and the air, iₐ=arcsin(n₃/n₂) , where n₃ is the refractive index of air (generally 1).

FIG. 5C, as shown, is another schematic diagram of light paths of the backlight module shown in FIG. 4. The present embodiment describes the condition that the length L₁ of the first inclined plane P1 in the y-direction perpendicular to the light-incident surface P3 satisfies with reference to the figure.

The incidence angle k₁ of the light which are emitted from a farthest end 211 of the light source 21 (the lowest point 211 in an x-direction perpendicular to the light-emergent surface) to a connecting position between the first inclined plane P1 and the light-emergent surface 221 is a light having the smallest incidence angle among the light directly emitted towards the light-emergent surface 221. As long as the incidence angle k₁ of the light is greater than or equal to the critical angle i_{g} of the interface between the bottom surface 222 and the glue layer 24, when the light directly emitted towards the light-emergent surface 221 is reflected towards the bottom surface 222, the incidence angles are greater than or equal to the critical angle i_{g} of the interface between the bottom surface 222 and the glue layer 24.

That is, a total reflection can occur on the light B₁ in FIG. 5A within the light guide plate before the light B₁ irradiates to the spot.

It can be seen from the geometric relationship shown in FIG. 5C, α=90°−k₁, tan α=h₁/(L₁+s), L₁=h₁/tan α−s, where L₁ is positively correlated with the value of k₁, when k₁=i_{g}, L₁ is the minimum value, i_{g} is the critical angle of the interface between the bottom surface 222 and the glue layer. That is, the length L₁ of the first inclined plane P1 in the y-direction perpendicular to the light-incident surface P3 satisfies the first length formula of L₁≥h₁/tan α−s, where L₁ is the length of the first inclined plane P1 in the y-direction perpendicular to the light-incident surface P3, h₁ is a farthest distance of the light source 21 to the light-emergent surface 221 in the x-direction perpendicular to the bottom surface, that is, the distance of the lowest point 211 of the luminous surface P4 of the light source 21 to the light-emergent surface 221 in the x-direction, α=90°−i_{g} , i_{g} is the critical angle of the interface between the bottom surface 222 and the glue layer, s is a vertical distance of the luminous surface P4 of the light source to the light-incident surface P3 of the light guide plate 22.

FIG. 5D, as shown, is another schematic diagram of light paths of the backlight module shown in FIG. 4. The present embodiment describes the condition that the angle of the first inclined plane P2 satisfies with reference to the figure.

The light emitted by the light source 21 enters the light-incident surface P3 and refracts, the incidence angle of the light directly emitted towards the second inclined plane P2 is generally greater than or equal to the critical angle iₐ of the interface between the light-emergent surface 221 and the air, so that a total reflection occurs. Whenever the second inclined plane P2 deflects counterclockwise by 1 degree from the position where it is coplanar with the light-emergent surface 221, the incidence angle of the light directly irradiating to the second inclined plane P2 is deflected counterclockwise by 1 degree. The incidence angle of the light emitted by the light source 21 towards the light-emergent surface 221 after being reflected by the second inclined plane P2 is i_{g}′. When the incidence angle of the light emitted by the light source 21 towards the interface between the bottom surface 222 and the glue surface 24, after being reflected by the second inclined plane P2 and the light-emergent surface 221, is the critical angle i_{g}, and the light-emergent surface 221 is parallel with the bottom surface 222, under the critical condition, i_{g}′=i_{g}. It can be seen according to the geometric relationship that f₂=i₂+iₐ=f₄, f₅=i_{g}−f₄=f₆=i₂, and thus i₂=(i_{g}−iₐ)/2, where i₂ is the angle between the second inclined plane P2 and the light-emergent surface 221, i_{g} is the critical angle of the interface between the bottom surface 222 and the glue layer, and iₐ is the critical angle of the interface between the light-emergent surface 221 and the air. Therefore, when i₂≥(i_{g}−iₐ)/2, the incidence angle of the light emitted by the light source 21 towards the light-emergent surface 221 after being reflected by the second inclined plane P2 will be greater than or equal to the critical angle i_{g} of the interface between the bottom surface 222 and the glue layer, and the incidence angle of the light emitted towards the bottom 222 after being reflected by the light-emergent surface 221 will be greater than or equal to the critical angle i_{g}, and thus a total reflection can occur on the light at the bottom surface without the light being emitted into the glue layer 24 from the bottom surface 222. With such an arrangement, a total reflection can occur on the light B₄ in FIG. 5A within the light guide plate before the light B₄ irradiates to the spot.

Therefore, the angle between the second inclined plane P2 and the bottom surface 222 satisfies a second angle formula of i₂ (i_{g}−iₐ)/2, where i₂ is the angle between the second inclined plane P2 and the bottom surface 222, i_{g} is the critical angle of the interface between the bottom surface 222 and the glue layer, i_{g}=arcsin(n₁/n₂), n₁ is the refractive index of the glue layer 24 (the refractive index of the glue layer is generally greater than 1 and less than the refractive index of the light guide plate, e.g., about 1.3), n₂ is the refractive index of the light guide plate 22 (e.g., about 1.49), and iₐ is the critical angle of the interface between the light-emergent surface 221 and the air, iₐ=arcsin(n₃ /n₂), where n₃ is the refractive index of air (generally 1).

FIG. 5E, as shown, is another schematic diagram of light paths of the backlight module shown in FIG. 4. The present embodiment describes the condition that the length L₂ of the second inclined plane P2 in the y-direction perpendicular to the light-incident surface P3 satisfies with reference to the figure.

The incidence angle k₂ of the light which are emitted from a farthest end 212 of the light source 21 (the highest point 211 in a x-direction perpendicular to the bottom surface 222) to a connecting position between the second inclined plane P2 and the bottom surface 222 is a light having the smallest incidence angle among the light directly emitted towards the bottom surface 222. As long as the incidence angle k₂ of the light is greater than or equal to the critical angle i_{g} of the interface between the bottom surface 222 and the glue surface 24, the incidence angle of the light directly emitted towards the bottom surface 222 is greater than or equal to the critical angle i_{g} of the interface between the bottom surface 222 and the glue layer 24. That is, a total reflection can occur on the light B₂ in FIG. 5A within the light guide plate before the light B₂ irradiates to the spot.

It can be seen from the geometric relationship shown in FIG. 5E, α=90°−k₂, tan α=h₂/(L₂+s), L₂=h₂/tan α−s, where L₂ is positively correlated with the value of k₂, when k₂=i_{g}, L₂ is the minimum value. That is, the length L₂ of the second inclined plane P2 in the y-direction perpendicular to the light-incident surface P3 satisfies a second length formula of L₂≥h₂/tan α−s, where L₂ is the length of the second inclined plane P2 in the y-direction perpendicular to the light-incident surface P3, h₂ is the farthest distance of the light source 21 to the bottom surface 222 in the x-direction perpendicular to the bottom surface 222, that is, the distance of the highest point 212 of the luminous surface P4 of the light source 21 to the bottom surface 222 in the x-direction, α=90°−i_{g}, i_{g} is the critical angle of the interface between the bottom surface 222 and the glue layer, s is a vertical distance of the luminous surface P4 of the light source 21 to the light-incident surface P3.

In some embodiments, the width of the luminous surface P4 of the light source 21 in the x-direction perpendicular to the light-emergent surface 221 is less than or equal to the width of the light-incident surface P3, which can avoid the light emitted from the luminous surface P4 of the light source 21 being irradiated to the outside of the light guide plate 21 in the x-direction perpendicular to the light-emergent surface 221 to the greatest extent, thereby avoiding the waste of the light energy.

In some embodiments, an orthographic projection of the luminous surface P4 of the light source 21 on the plane in which the light-incident surface P3 lies is located in the light-incident surface P3, so that it is difficult for the light emitted from the luminous surface P4 to be emitted to the outside of the light guide plate 21 in both x-direction perpendicular to the light-emergent surface 221 and y-direction perpendicular to the light-incident surface, thereby avoiding the waste of the light energy more effectively.

In some embodiments, the luminous surface P4 of the light source 21 is of a rectangular shape, and the orthographic projection of the luminous surface P4 of the light source 21 on the plane in which the light-incident surface P3 is located lies at the center of the light-incident surface P3. With such an arrangement, the angle between the first inclined plane P1 and the light-emergent surface 221 may be the same as the angle between the second inclined plane P2 and the bottom surface 222, and the lengths of the first inclined plane P1 and the second inclined plane P2 are the same in the direction parallel with the light-emergent surface 221.

In some embodiments, the distance between the light source 21, such as the luminous surface, and the light-incident surface P3 is less than 2 mm. Compared with a larger distance, a smaller distance can also prevent light from being emitted to the outside of the light guide plate.

In some embodiments, the first inclined plane P1 and the second inclined plane P2 are symmetric with respect to a central axis plane between the light-emergent surface 221 and the bottom surface 222, where the central axis plane is a plane located between the light-emergent surface 221 and the bottom surface 222 and has a same distance to the light-emergent surface 221 and the bottom surface 222. When the light-emergent surface 221 is parallel with the bottom surface 222, the central axis plane is a plane located between the light-emergent surface 221 and the bottom surface 222 and parallel with the light-emergent surface 221 and the bottom surface 222.

In some embodiments, the first inclined plane P1 and the second inclined plane P2 are made by a grinding process. Alternatively, the first inclined plane P1 and the second inclined plane P2 are formed by pressing and adjusting the distance between the pressing rollers when forming the light guide plate 22.

In some embodiments, a light-reflecting layer 25 is provided at an outer side of the first inclined plane P1 and the second inclined plane P2. Since the first inclined plane P1 and the second inclined plane P2 may be not smooth enough after being processed and formed, which may cause a problem that it is difficult for the first inclined plane P1 and the second inclined plane P2 to reflect normally, and the light-reflecting layer 25 may prevent the problem from occurring.

In some embodiments, the light-reflecting layer 25 provided at the outer side of the first inclined plane P1 and the second inclined plane P2 may be a silver-plated layer or a silver-coated reflective layer.

In addition, the backlight module provided by the embodiments of the present disclosure may further include an optical film, etc., which is not limited by the embodiments of the present disclosure.

In addition, the embodiments of the present disclosure further provide a display device, which includes the backlight module shown in FIG. 3 or the backlight module shown in FIG. 4. The display device may further include a display panel, etc, which is not limited by the embodiments of the present disclosure.

In the present disclosure, the terms “first” and “second” are used for descriptive purposes only and are not to be construed as indicating or implying relative importance.

The “perpendicular” and “parallel” in the present disclosure are neither “perpendicular” nor “parallel” in the mathematical sense. Instead, on the assumption that the display effect is satisfied, there may be error for the “perpendicular” and “parallel” with respect to the “perpendicular” and “ parallel” in the mathematical sense to some extent.

The above description is only the preferred embodiments of the present disclosure and is not intended to limit the present disclosure. Any modifications, equivalent substitutions, improvements, etc. within the spirit and principle of the present disclosure should be included within the protection scope of the present disclosure.

What is claimed is:

1. A backlight module, comprising: a light source, a light guide plate and a reflection sheet; wherein the light source and the reflection sheet are located outside of the light guide plate, and the light guide plate comprises:
a bottom surface disposed opposite to the reflection sheet;
a light-emergent surface disposed opposite to the bottom surface and parallel with the bottom surface;
a light-incident surface located at a side of the light guide plate, perpendicular to the bottom surface and disposed opposite to the light source;
a first inclined plane disposed between the light-incident surface and the light-emergent surface;
a second inclined plane disposed between the light-incident surface and the bottom surface.

2. The backlight module of claim 1, wherein a light-reflecting layer is provided at an outer side of the first inclined plane and the second inclined plane.

3. The backlight module of claim 2, wherein the light-reflecting layer is a silver-plated layer or a silver-coated reflective layer.

4. The backlight module of claim 1, wherein a width of a luminous surface of the light source is less than or equal to a width of the light-incident surface in a direction perpendicular to the light-emergent surface.

5. The backlight module of claim 1, wherein an orthographic projection of a luminous surface of the light source on a plane in which the light-incident surface lies is located in the light-incident surface.

6. The backlight module of claim 1, wherein a luminous surface of the light source is of a rectangular shape, and an orthographic projection of the luminous surface of the light source on a plane in which the light-incident surface lies is located at a center of the light-incident surface.

7. The backlight module of claim 1, wherein the first inclined plane and the second inclined plane are symmetric with respect to a central axis plane between the light-emergent surface and the bottom surface, and a distance from the central axis plane to the light-emergent surface is same as a distance from the central axis plane to the bottom surface.

8. The backlight module of claim 1, wherein the first inclined plane and the second inclined plane are made through a grinding process.

9. The backlight module of claim 1, wherein the first inclined surface and the second inclined surface are formed by pressing a pressing roller when forming the light guide plate.

10. The backlight module of claim 1, wherein a distance between the light source and the light-incident surface is less than 2 mm

11. The backlight module of claim 1, wherein the light source comprises a light emitting diode.

12. The backlight module of claim 1, further comprising a glue layer, wherein the reflection sheet is adhered to the bottom surface of the light guide plate through the glue layer, wherein a minimum incidence angle of light emitted from the first inclined surface towards the bottom surface of the light guide plate is greater than or equal to a critical angle of an interface between the light guide plate and the glue layer.

13. The backlight module of claim 1, wherein the luminous surface of the light source is parallel with the light-incident surface,
an angle i₁ between the first inclined surface and the light-emergent surface satisfies a first angle formula of i₁≥(i_{g}−iₐ)/2, wherein i₁ is the angle between the first inclined plane and the light-emergent surface, i_{g} is a critical angle of an interface between the bottom surface and the glue layer, iₐ is a critical angle of an interface between the light-emergent surface and the air;
a length L₁ of the first inclined plane in a direction perpendicular to the light-incident surface satisfies a first length formula of L₁≥h₁/tan α−s, wherein L₁ is the length of the first inclined plane in the direction perpendicular to the light-incident surface, h₁ is a farthest distance of a luminous surface of the light source to the light-emergent surface in a direction perpendicular to the bottom surface, α=90°−i_{g}, and s is a vertical distance of the luminous surface of the light source to the light-incident surface.

14. The backlight module of claim 1, wherein the luminous surface of the light source is parallel with the light-incident surface,
an angle i₂ between the second inclined surface and the bottom surface satisfies a second angle formula of i₂≥(i_{g}−iₐ)/2, wherein i₂ is the angle between the second inclined plane and the bottom surface, i_{g} is a critical angle of an interface between the bottom surface and the glue layer, iₐ is a critical angle of an interface between the light-emergent surface and the air;
a length L₂ of the second inclined plane in a direction perpendicular to the light-incident surface satisfies a second length formula of L₂≥h₂/tan α−s, wherein L₂ is the length of the second inclined plane in the direction perpendicular to the light-incident surface, h₂ is a farthest distance of a luminous surface of the light source to the bottom surface in a direction perpendicular to the bottom surface, α=90°−i_{g} , and s is a vertical distance of the luminous surface of the light source to the light-incident surface.

15. The backlight module of claim 1, wherein an intersecting line between a plane in which the first inclined plane lies and a plane in which the second inclined plane lies is located outside of the light guide plate, and the intersecting line is parallel with the bottom surface, and the first inclined plane and the second inclined plane are configured such that a total reflection occurs on at least part of light emitted from the light-incident surface to the first inclined plane at the first inclined plane, a total reflection occurs on at least part of light emitted from the light-incident surface to the second inclined plane at the second inclined plane.

16. A display device, comprising the backlight module of claim 1.
